(19) United States
(12) Patent Application Publication
(10) Pub. No.: US 2007/0235203 A1
(43) Pub. Date: Oct. 11, 2007

(54) Tool bar mounting structure for self-propelled sprayer vehicles

(76) Inventors: Brian Bergstrom, Axtell, NE (US); Jenice Bergstrom, Axtell, NE (US)

Correspondence Address: Law Offices of Adam H. Jacobs, Suite 726, 1904 Farnam Street, Omaha, NE, 68102, US

(21) Appl. No.: 11/375,300

(22) Filed: Mar. 14, 2006

(51) Int. Cl. A01B 63/00

(52) U.S. Cl. 172/452; 172/681

(57) ABSTRACT

A tool bar mounting structure for a self-propelled field sprayer vehicle includes a chassis mount beam for mounting on the chassis of the field sprayer vehicle and two main mount beams pivotably mounted on the chassis mount beam and extending to a position underneath the chassis. A main mount beam lifting mechanism is connected to and extends between the main mount beam and the chassis of the field sprayer vehicle for raising and lowering of the main mount beam. A shock absorber device is mounted on the main mount beam with the upper end thereof connectable to the field sprayer vehicle for generally controlling and limiting vertical movement of the tool bar connection end of the main mount beam. The tool bar connection end is positioned such that when a tool bar is mounted thereon, it is positioned between the front and rear wheels of the field sprayer vehicle.

### BACKGROUND OF THE INVENTION

1. Technical Field

The present invention is directed to tool bar mounting structures for agricultural vehicles and, more particularly, to an under chassis tool bar mounting structure for agricultural field sprayer vehicles which includes a downwardly depending chassis mount beam which is mountable on the chassis of a field sprayer vehicle, at least one main mount beam pivotally mounted on a lower end of the chassis mount beam and extending underneath the field sprayer vehicle, a shock absorber device mounted on the main mount beam and connectable to the field sprayer vehicle for controlling and limiting vehicle movement of the tool bar connection end of the main mount beam, the tool bar connection end of the main mount beam being positioned underneath the field sprayer vehicle such that the tool bar, when mounted thereon, extends out to the side of the sprayer vehicle between the front and rear wheels to permit the field sprayer vehicle to be used for additional purposes beyond that which it was originally designed to perform.

2. Description of the Prior Art

Ideally, the modern farmer would own a number of different vehicles for use in tending his or her fields, including tractors, field sprayers, combines, etc., each of which are designed to perform particular tasks in an efficient manner. The reality, however, is that many farmers cannot afford multiple vehicles each having a particular purpose simply due to financial constraints. The ordinary farmer must then make do with whatever vehicles he or she has available and therefore it would be beneficial to the farmer to increase the functional flexibility of those vehicles he or she currently owns.

One very useful vehicle for limited purposes is the self-propelled sprayer which includes an elevated chassis to provide clearance for mature crops being grown in the field. It is often necessary for the farmer to spray pesticides, insecticides, or fertilizers on crops which are already growing, and many vehicles available for use on the farm do not provide sufficient undercarriage clearance to apply these chemicals without damaging the crops. It is therefore quite common for farmers to own a self-propelled sprayer for these purposes. However, those same described features which allow the sprayer to be so very useful in applying pesticides, insecticides, and fertilizers render it virtually unusable for most other applications such as planting the field. Because of the high center of gravity and high ground clearance of the self-propelled sprayer, it simply is not possible to utilize a standard tool bar in connection with the sprayer, and thus the sprayer can only be used for its intended limited purposes. There is therefore a need for a tool bar attachment structure for a self-propelled sprayer which will permit the sprayer to be used for other purposes besides merely applying various chemicals to the crops.

Several devices have been proposed in the prior art which attempt to provide improved tool bar attachment structures, including Follmer, U.S. Pat. No. 5,809,114, Friggstaad, et al., U.S. Pat. No. 6,371,216, and Foley, U.S. Pat. No. 5,163,518, but each of these devices designed for use with tractors and the like, and none of the prior art devices attempt to address and solve the problem of connecting a tool bar to a self-propelled sprayer to increase the flexibility and usability of the sprayer beyond merely spraying the field. Moreover, the vast majority of prior art devices disclose tool bar attachment structures which attach the tool bar to the front or rear of the vehicle, and the significant disadvantage of this type of attachment is that the center of the gravity for the vehicle is thus shifted forwards or rearwards depending on the location of the tool bar. While this does not present a significant problem when used in connection with vehicles with low centers of gravity, such as tractors and the like, to use such a device in connection with a self-propelled sprayer having a high center of gravity would significantly modify the location of the center of gravity and likely render the self-propelled sprayer vehicle unstable for use in the field, particularly in fields having significant slopes. There is therefore a need for a tool bar attachment structure for a self-propelled sprayer that will not significantly degrade the stability of the sprayer vehicle.

Therefore, an object of the present invention is to provide a tool bar mounting structure for a self-propelled sprayer vehicle.

Another object of the present invention is to provide a tool bar mounting structure for self-propelled sprayers which includes a downwardly depending chassis mount beam mounted on the chassis of a field sprayer vehicle, at least one main mount beam having one end pivotably mounted on the lower end of the chassis mount beam and having an opposite tool bar connection end, the main mount beam extending underneath the field sprayer vehicle, a shock absorber device mounted on the main mount beam and connectable to the field sprayer vehicle for generally controlling and limiting vertical movement of the tool bar connection end of the main mount beam, and upon the tool bar mounting structure being mounted on a field sprayer vehicle, the tool bar connection end of the main mount beam is positioned between the front and rear wheels whereby a tool bar mounted thereon is positioned between the front and rear wheels of the field sprayer vehicle.

Another object of the present invention is to provide a tool bar mounting structure for a self-propelled sprayer vehicle which is relatively simple to mount on the field sprayer vehicle to allow use of a tool bar attachment and which may then be quickly and easily removed from the field sprayer vehicle to permit the field sprayer vehicle to be used for spraying purposes.

Another object of the present invention is to provide a tool bar mounting structure for a field sprayer vehicle which will support the tool bar underneath the field sprayer vehicle's chassis between the front and rear wheels of the field sprayer vehicle in order to prevent substantial modification of the center of gravity of the field sprayer vehicle to the front or rear of the vehicle, thus acting to ensure stability of the vehicle even with the tool bar mounted thereon.

Another object of the present invention is to provide a tool bar mounting structure for a field sprayer vehicle which will significantly expand the range of uses of the field sprayer vehicle by permitting the field sprayer vehicle to be used in connection with a tool bar attachment for planting, furrowing, and other such field manipulation activity.

Finally, an object of the present invention is to provide the tool bar mounting structure for a field sprayer vehicle which is relatively simple and durable in construction and application and is safe, effective, and efficient in use.

### SUMMARY OF THE INVENTION

The present invention provides a tool bar mounting structure for a self-propelled field sprayer vehicle having a chassis, front and rear wheels, and an engine, the tool bar mounting structure including a downwardly depending chassis mount beam having an upper end and a lower end, the chassis mount beam adapted to be mounted on the chassis of the field sprayer vehicle. At least one main mount beam having a pivot mount end and a tool bar connection end is pivotably mounted on the lower end of the chassis mount beam on the pivot mount end of the main mount beam, with the main mount beam extending from the chassis mount beam to a position underneath the field sprayer vehicle. A main mount beam lifting mechanism including at least one hydraulic lifting cylinder connected at the lower end to the at least one main mount beam and adapted for connection of the upper end of the at least one hydraulic lifting cylinder to the chassis of the field sprayer vehicle for raising and lowering of the tool bar connection end of the at least one main mount beam relative to the field sprayer vehicle. A shock absorber device is mounted on the main mount beam with the upper end thereof connectable to the field sprayer vehicle for generally controlling and limiting vertical movement of the tool bar connection end of the main mount beam. Finally, upon the tool bar mounting structure beam mounted on a field sprayer vehicle, the tool bar connection end is positioned between the front and rear wheels whereby a tool bar mounted thereon is positioned between the front and rear wheels of the field sprayer vehicle to prevent substantial shifting of the center of balance of the field sprayer vehicle forward or rearward on the vehicle.

As thus described, the tool bar mounting structure for field sprayer vehicles of the present invention provides numerous advantages over those tool bar mounting structures found in the prior art. For example, because the tool bar is mounted beneath the chassis of the field sprayer vehicle between the front and rear wheels of the vehicle, the center of gravity of the field sprayer vehicle is not significantly shifted forwards or rearwards on the vehicle, thus preventing compromise of the stability of the field sprayer vehicle when in use. Furthermore, because the vertical movement of the tool bar is isolated from the chassis of the field sprayer vehicle due to the pivoting connection of the main mount beam to the chassis mount beam and the inclusion of the shock absorber devices, use of the present invention with the field sprayer vehicle will not damage the field sprayer vehicle despite the field sprayer vehicle being used for different purposes than that for which it was originally designed. Also, because the present invention permits the field sprayer vehicle to be used for many additional purposes, the functional utility of the field sprayer vehicle is greatly expanded, thus making it possible for farmers not able to afford some non-essential types of equipment to be competitive with those farmers who can afford such equipment. Finally, because the tool bar mounting structure of the present invention is designed to be mounted on and removed from the field sprayer vehicle in a relatively short amount of time, the farmer using the present invention is afforded greater flexibility with use of his or her farm vehicles, thus making it easier for the farmer to compete with large or corporate farms which often have an unfair advantage. The tool bar mounting structure for field sprayer vehicles of the present invention thus provides substantial improvement over those tool bar mounting structures found in the prior art.

### BRIEF DESCRIPTION OF THE DRAWINGS

FIG. 1 is a perspective view of the tool bar mounting structure of the present invention mounted on a field sprayer vehicle with a tool bar attached thereto;

FIG. 2 is a side elevational view of the present invention mounted on a field sprayer vehicle;

FIG. 3 is a front elevational view of the present invention mounted on a field sprayer vehicle;

FIG. 4 is a perspective view of the tool bar mounting structure of the present invention;

FIG. 5 is a detailed side elevational view of the present invention showing how the structure may be moved up and down to adjust the height of the tool bar relative to the ground surface; and

FIGS. 6 and 7 are detailed side elevational views of the shock absorber element of the present invention showing how movement of the main mount beam is generally restricted and controlled.

### DESCRIPTION OF THE PREFERRED EMBODIMENT

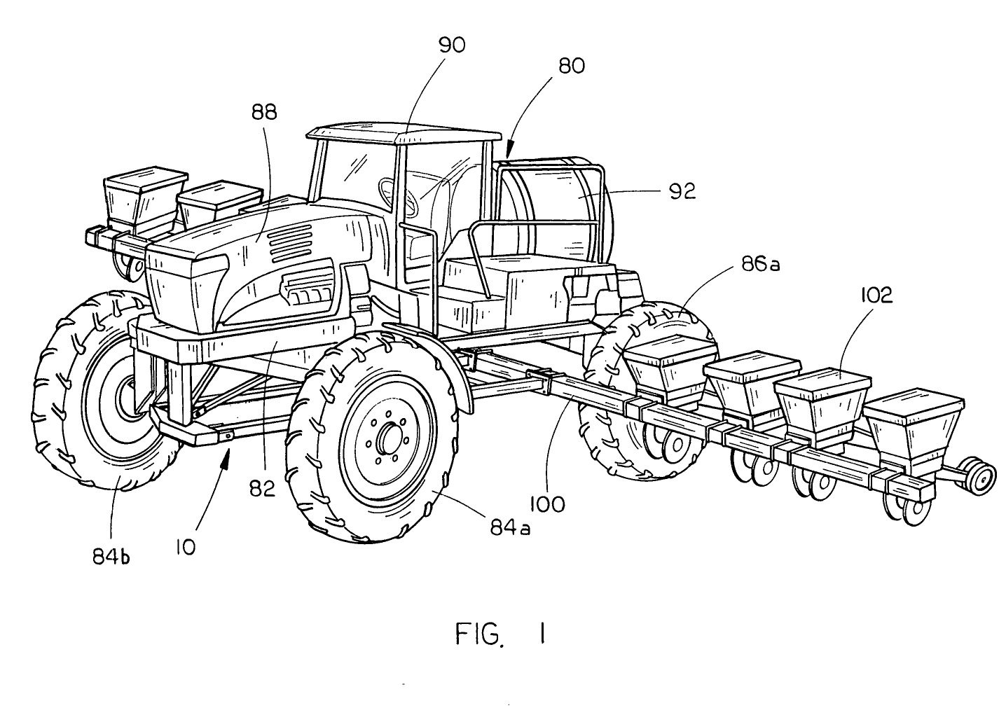

The tool bar mounting structure 10 of the present invention is shown best in FIGS. 1-5 as being mounted on a self-propelled field sprayer vehicle 80, the field sprayer vehicle 80 including a chassis 82, front wheels 84a and 84b, rear wheels 86a and 86b, an engine 88, a cab structure 90, and a sprayer fluid tank 92. An example of such a field sprayer vehicle 80 would be the John Deere Model 4720 self-propelled sprayer, although the present invention is designed to function with virtually any type of self-propelled sprayer vehicle with only minor modifications. As can be seen, the field sprayer vehicle 80 includes a very high ground clearance which makes it ideal for spraying maturing crops in the field, but less than ideal for use in planting or for furrowing operations, specifically those which utilize a tool bar being mounted to the vehicle. The present invention, however, is intended to solve that problem and significantly increase the usability of the field sprayer vehicle 80.

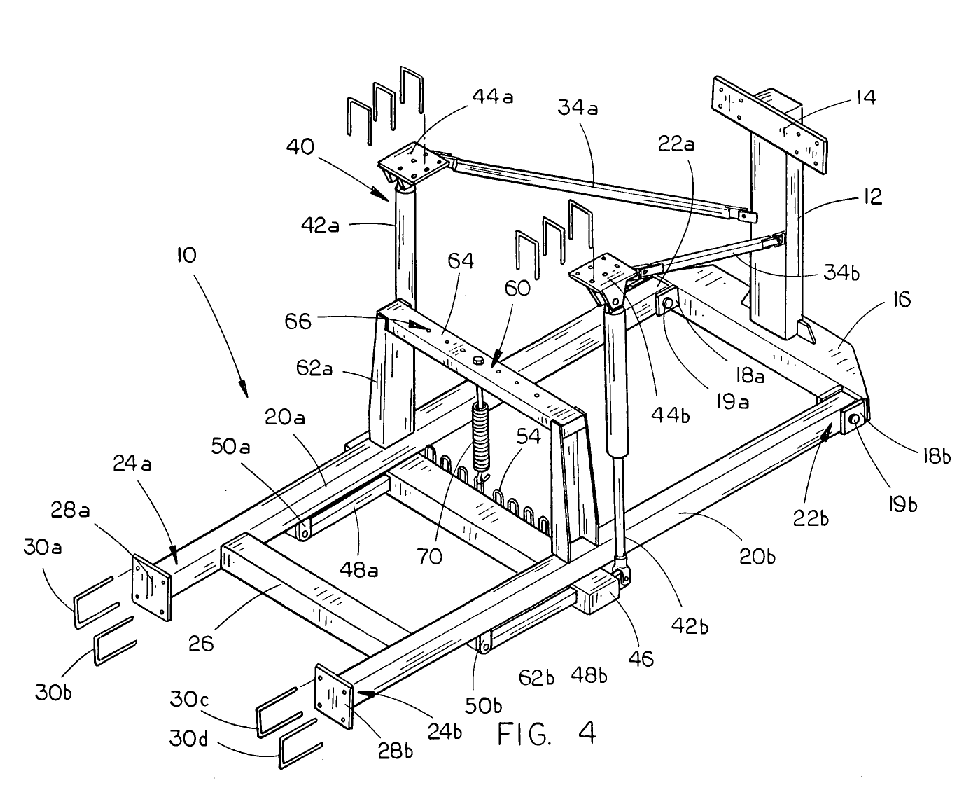

As show best in FIG. 4, the tool bar mounting structure 10 of the present invention includes a chassis mount beam 12 having a chassis mount beam mounting plate 14 mounted on the upper end thereof, the chassis mount beam 12 having a length of approximately two to four feet with the chassis mount beam 12 being constructed of a very heavy square or rectangular box beam construction. The connection of the chassis mount beam 12 to the field sprayer vehicle 80 would preferably be via U-bolts, regular bolts or another such releasable and replaceable connection device, with the chassis mount beam mounting plate 14 being in contact with the chassis 82 of the field sprayer vehicle 80 adjacent the forward end thereof and releasably connected thereto. As this connection is subject to significant stress, it is preferred that whatever the specific design of the connection, the connection should be very stable and strong yet generally easily releasable for removal of the tool bar mounting structure 10 when it is not being used.

Mounted on the lower end of chassis mount beam 12 and extending generally perpendicular thereto is main mount beam mounting arm 16 which, in the preferred embodiment, would be a horizontal beam having a width of approximately three to five feet and which further includes a pair of main mount beam mounting brackets 18a and 18b mounted at opposite ends of main mount beam mounting arm 16, as shown best in FIG. 4. It should be noted that each of the elements of the tool bar mounting structure 10, as described herein, would be constructed of heavy-duty steel or metal construction, with the precise size, shape, and construction materials being modifiable or changeable so long as the functional characteristics of each of the elements are generally maintained.

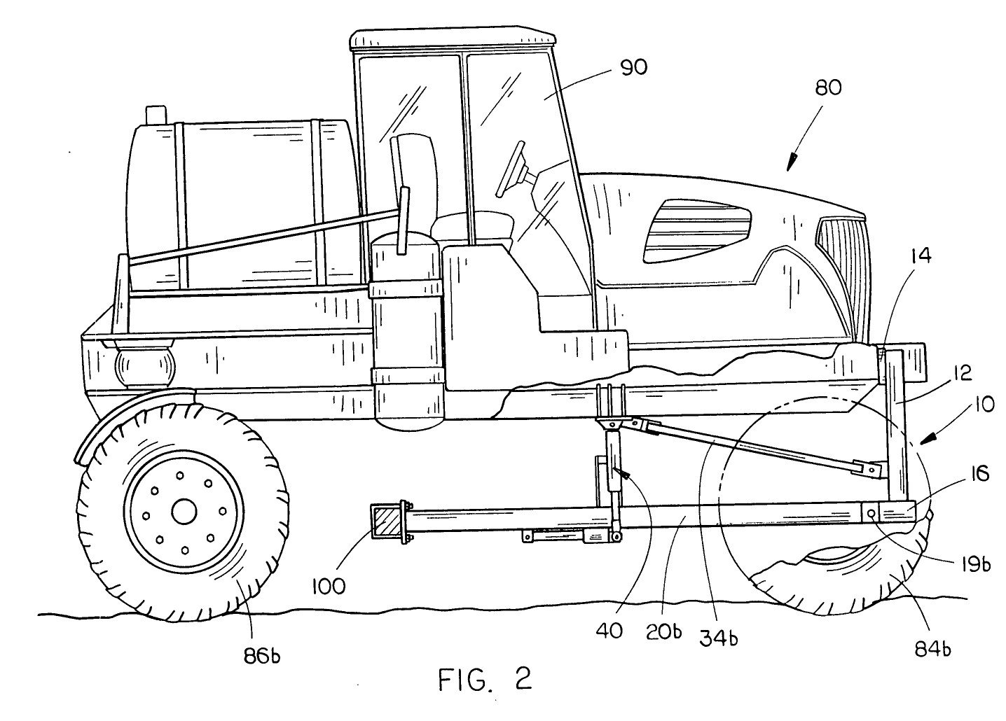

Pivotally mounted on and extending rearwards from main mount beam mounting arm 16, specifically, main mount beam mounting brackets 18a and 18b, are a pair of main mount beams 20a and 20b which, in the preferred embodiment, are a pair of square box beams approximately four to six inches in width and each having lengths of approximately eight to twelve feet, as shown best in FIG. 4. In the preferred embodiment, the main mount beams 20a and 20b would be connected to the main mount beam mounting brackets 18a and 18b by bolts 19a and 19b which extend through the main mount beam mounting brackets 18a and 18b and through the pivot mount end 22a and 22b of each of the main mount beams 20a and 20b such that the bolts 19a and 19b each form pivot axes about which the main mount beams 20a and 20b can pivot in generally parallel upright planes. The important consideration regarding the length of the main mount beams 20a and 20b is that the tool bar connection ends 24a and 24b of the main mount beams 20a and 20b should be positioned between the front wheels 84a and 84b and rear wheels 86a and 86b of the field sprayer vehicle 80 when the tool bar mounting structure 10 is mounted on the field sprayer vehicle 80, as shown best in FIGS. 1 and 2. Therefore, to some extent, the length of the main mount beams 20a and 20b will be dependent on the overall chassis length of the chassis 82 of the field sprayer vehicle 80, although it has been found that generally a length of between eight and twelve feet for the main mount beams 20a and 20b will correctly position the tool bar connection ends 24a and 24b of the main mount beams 20a and 20b underneath the chassis 82.

Extending between and connecting the main mount beams 20a and 20b is a rear spacer strut 26 which secures the main mount beams 20a and 20b to one another generally adjacent the tool bar connection ends 24a and 24b of the main mount beams 20a and 20b, and it is further preferred that each of the main mount beams 20a and 20b further include tool bar mounting plates 28a and 28b mounted on the tool bar connection ends 24a and 24b of the main mount beams 20a and 20b, as shown best in FIG. 4. As shown best in FIG. 1, the tool bar 100 would be mounted on the main mount beams 20a and 20b via connection of the tool bar 100 to the tool bar mounting plates 28a and 28b by U-bolts 30a, 30b, 30c, and 30d which releasably secure the tool bar 100 on the tool bar mounting plates 28a and 28b. Of course, the particular mechanism by which the tool bar 100 is mounted on the main mount beams 20a and 20b is not critical to the present invention so long as the connection of the main mount beams 20a and 20b to the tool bar 100 is sturdy, safe, and releasable.

It should be noted that the tool bar 100 would preferably be a standard make and model, and would generally be a rectangular box beam having a length of approximately ten to twenty feet (10′ to 20′) with any appropriate farming tools mounted thereon. The tool bar 100 is well-known in the prior art, and therefore further description of the tool bar herein will not be provided.

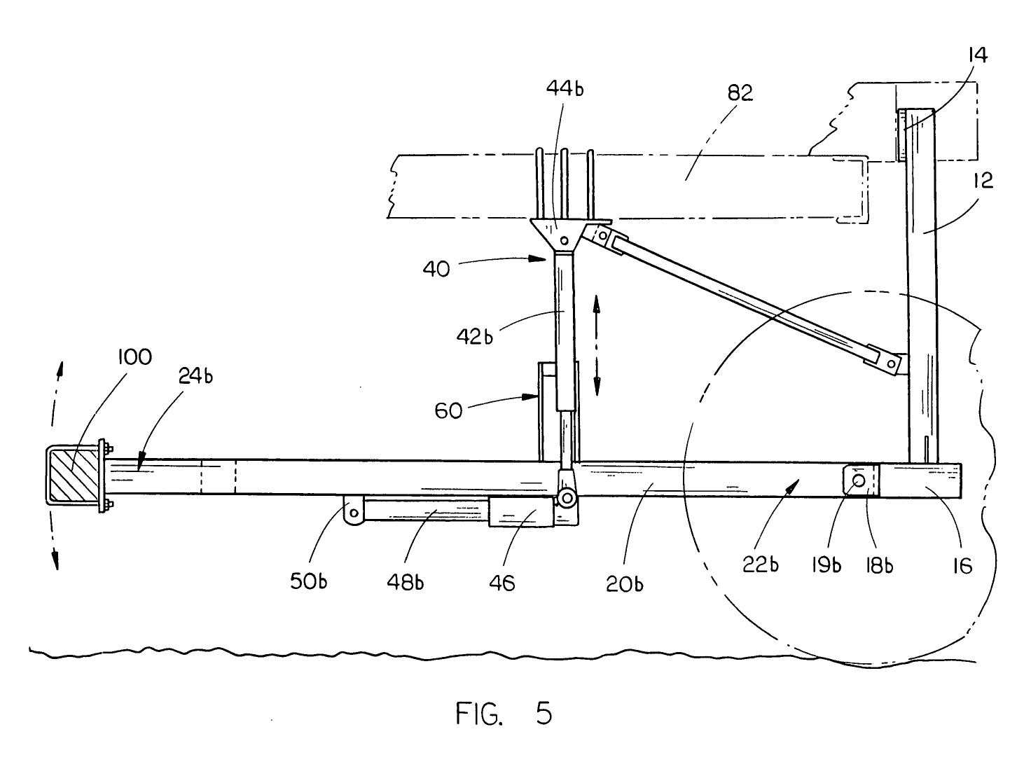

The main mount beam lifting mechanism 40 is shown best in FIGS. 4 and 5 as including a pair of hydraulic lifting cylinders 42a and 42b which are pivotably connected to a pair of cylinder mounting brackets 44a and 44b which are mounted to the chassis 82 of the field sprayer vehicle 80, as shown in FIGS. 2 and 5. The lower ends of the hydraulic lifting cylinders 42a and 42b are connected to a lifting mechanism support beam 46 which extends between the lower ends of the hydraulic lifting cylinders 42a and 42b underneath the main mount beams 20a and 20b, as shown in FIGS. 4 and 5, with the hydraulic lifting cylinders 42a and 42b being pivotably mounted on the lifting mechanism support beam 46.

A pair of support beam mounting struts 48a and 48b extend rearwards from the lifting mechanism support beam 46 and are pivotably mounted to the underside of the main mount beams 20a and 20b by a pair of support beam mounting strut brackets 50a and 50b, as shown best in FIGS. 4 and 5. This arrangement of elements in the main mount beam lifting mechanism 40 means that the main mount beams 20a and 20b are supported by the lifting mechanism support beam 46, but if the main mount beams 20a and 20b pivot upwards about bolts 19a and 19b in a rapid fashion, as would occur if an obstacle or impediment were encountered by the implements mounted on the tool bar 100 during tilling or planting, the main mount beams 20a and 20b may move upwards without damaging the hydraulic lifting cylinders 42a and 42b, as the main mount beams 20a and 20b would lift off of the lifting mechanism support beam 46 by pivoting about the support beam mounting strut brackets 50a and 50b and, once the impediment has been passed, the main mount beams 20a and 20b would then fall back down onto the lifting mechanism support beam 46 to the predetermined height set by the extension or retraction of the hydraulic lifting cylinders 42a and 42b of main mount beam lifting mechanism 40.

While the main mount beam lifting mechanism 40 provides the mechanism for adjusting the height of the tool bar connection ends 24a and 24b of main mount beams 20a and 20b, and therefore provides for vertical adjustment of the height of tool bar 100 when mounted thereon, it is necessary to include an additional structure on the tool bar mounting structure 10 which will permit the implements mounted on tool bar 100 to function correctly and also prevent uncontrolled, unlimited movement of the main mount beams 20a and 20b about the bolts 19a and 19b due to the tool bar implements encountering impediments and objects during their functioning. Specifically, the present invention further provides a down pressure shock absorber structure 60 which, in the preferred embodiment, would include the following elements. A pair of upright support legs 62a and 62b would each extend upwards from one of the main mount beams 20a and 20b, as shown best in FIGS. 4 and 5. Extending between and connecting the top ends of upright support legs 62a and 62b is a top spring mount beam 64 which includes a plurality of spring mount holes 66 formed extending generally vertically through the spring mount beam 64, as shown best in FIG. 4. Mounted on lifting mechanism support beam 46 are a plurality of spring mount metal loops 54 which, in the preferred embodiment, would be positioned generally beneath the spring mount holes 66 in top spring mount beam 64. One or more down pressure springs 70 may be mounted in the spring mount holes 66 and connected to the spring mount loops 54, the down pressure springs 70 pulling the lifting mechanism support beam 46 towards the top spring mount beam 64, and therefore pulling the main mount beams 20a and 20b downwards onto the lifting mechanism support beam 46. The amount of down pressure may be adjusted by adding or subtracting down pressure springs 70 to extend between and connect the various spring mount holes 66 and spring mount loops 54 thereby increasing or decreasing the amount of down pressure force exerted on main mount beams 20a and 20b towards lifting mechanism support beam 46.

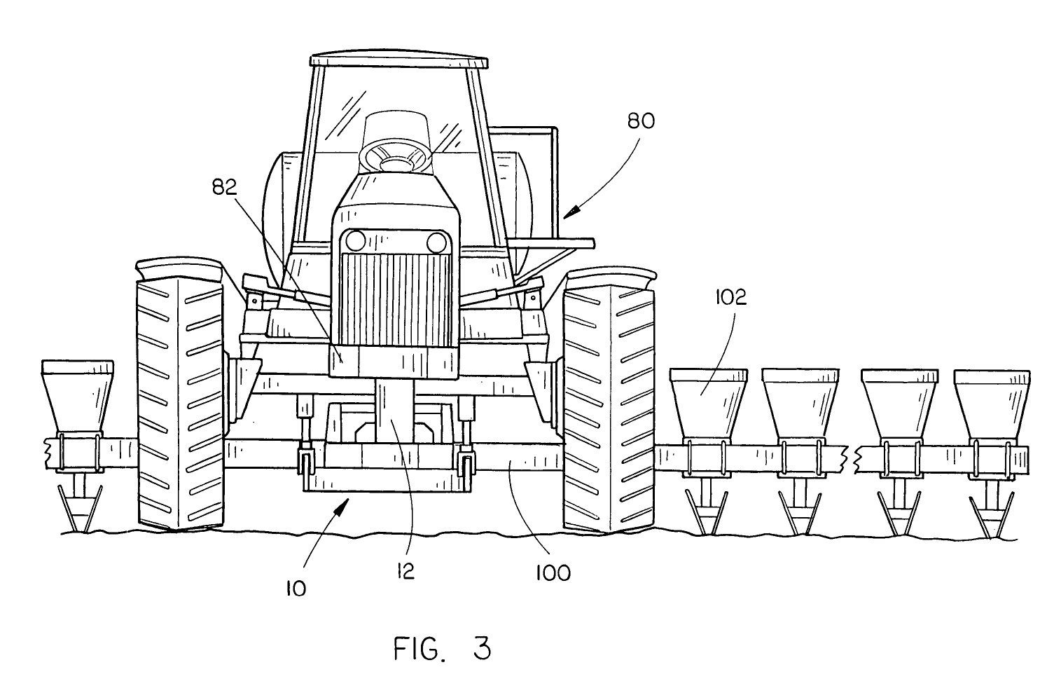

The tool bar mounting structure 10 of the present invention would function in the following manner. Initially, the chassis mount beam mounting plate 14 and cylinder mounting brackets 44a and 44b would be mounted to the chassis 82 of the field sprayer vehicle 80, as shown best in FIGS. 1-3. In the preferred embodiment, a plurality of U-bolts would be used to mount the chassis mount beam mounting plate 14 and cylinder mounting brackets 44a and 44b to the chassis 82, although the specific mounting mechanism by which the tool bar mounting structure 10 of the present invention is mounted to the field sprayer vehicle 80 is only critical in that it should be relatively easy to attach and remove the toll bar mounting structure 10 to the field sprayer vehicle 80 and, once attached, the tool bar mounting structure 10 should be securely and safely mounted thereon. It may also be preferable to include a pair of bracing struts 34a and 34b which extend between and connect the chassis mount beam 12 and cylinder mounting brackets 44a and 44b to provide additional structural stability to the tool bar mounting structure 10, although the inclusion of such bracing struts 34a and 34b is not particularly critical to the proper functioning of the present invention. Once the tool bar mounting structure 10 is properly mounted on the chassis 82 of the field sprayer vehicle 80, the tool bar 100 and tool bar implements 102 would be mounted to the tool bar connection ends 24a and 24b of main mount beams 20a and 20b, as shown best in FIGS. 1 and 3, via U-bolts 30a-d. The tool bar 100 would then be positioned at the proper operating height via extension or retraction of hydraulic lifting cylinders 42a and 42b from controls mounted within the cab structure 90 of the self-propelled field sprayer vehicle 80, and the appropriate amount of down pressure force would be applied to the tool bar 100 by extending the hydraulic lifting cylinders 42a and 42b downwards to tension the down pressure springs 70 as the main mount beams 20a and 20b attempt to lift off the lifting mechanism support beam 46. Once the appropriate position of the hydraulic lifting cylinders 42a and 42b has been set, the field sprayer vehicle 80 fitted with the tool bar mounting structure 10 of the present invention is ready for operation.

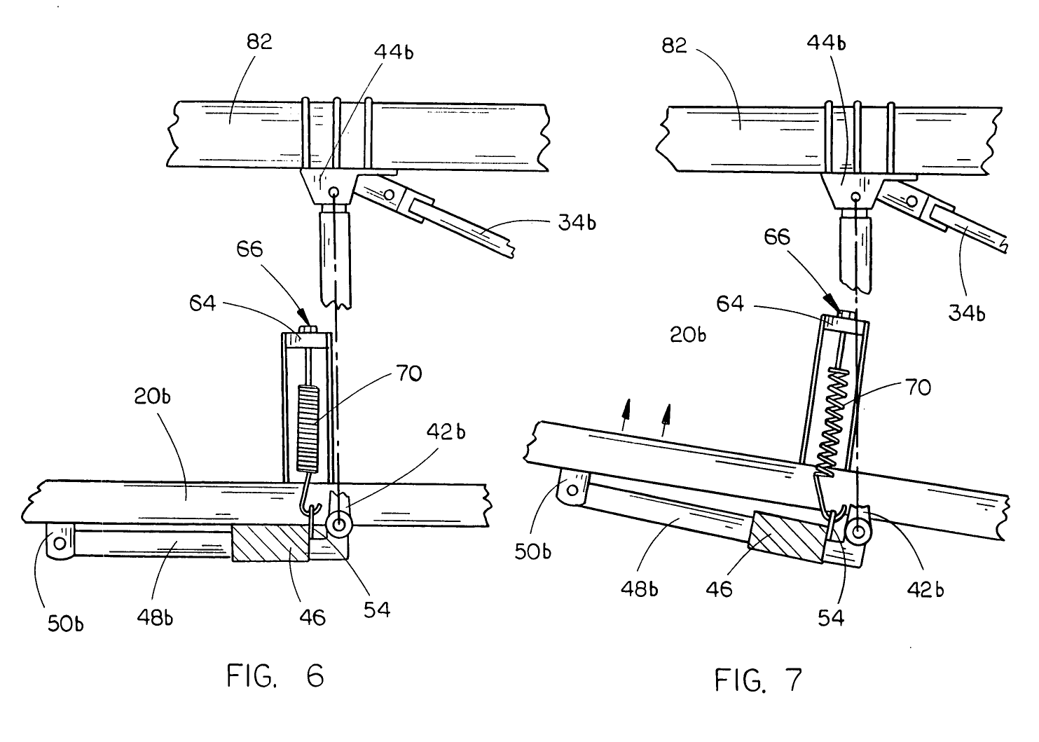

During movement of the field sprayer vehicle 80, it is entirely possible that the tool bar implements 102 mounted on tool bar 100 will encounter some obstructions which will cause the tool bar 100 to move upwards relative to the ground surface over which the field sprayer vehicle 80 is traveling. When this happens, the down pressure shock absorber structure 60 reacts as shown in FIGS. 6 and 7, in that the upwards movement of the main mount beams 20a and 20b about bolts 19a and 19b causes the down pressure springs 70 to be tensioned as the top spring mount beam 64 moves away from the lifting mechanism support beam 46. This increases the down pressure force being applied to the main mount beams 20a and 20b by the down pressure springs 70 and therefore, once the obstruction has been surmounted, the main mount beams 20a and 20b are brought back into contact with the lifting mechanism support beam 46 through the retraction of down pressure springs 70. This ability of the down pressure shock absorber structure 60 to respond to upwards movement of the main mount beams 20a and 20b acts to prevent damage to the hydraulic lifting cylinders 42a and 42b from sudden extension or compression of the hydraulic lifting cylinders 42a and 42b due to movement of the main mount beams 20a and 20b, and therefore the down pressure shock absorber structure 60 is a vital element of the present invention.

Once a user of the present invention has completed their intended operations utilizing the tool bar 100, the tool bar mounting structure 100 would then be easily removed from the chassis 82 of the field sprayer vehicle 80 merely by reversing the installation process and then driving the field sprayer vehicle 80 away from the dismounted tool bar mounting structure 10. The field sprayer vehicle 80 would then be ready for standard operation, as per the intentions of the designer of the field sprayer vehicle 80.

It is important to note that the tool bar mounting structure 10 of the present invention supports the tool bar 100 between the front wheels 84a and 84b and rear wheels 86a and 86b of the field sprayer vehicle 80, thus permitting the field sprayer vehicle 80 to be driven in a generally normal manner. Were the tool bar 100 to be supported in front of or to the rear of the field sprayer vehicle 80, it is quite likely that the center of gravity of the field sprayer vehicle 80 would be moved significantly forward or rearward depending on the location of the tool bar 100, thus compromising the ability of the field sprayer vehicle 80 to be driven normally. It is therefore an important feature of the present invention that the tool bar mounting structure 10 permits mounting of the tool bar 100 directly underneath chassis 82 of the field sprayer vehicle 80. It should also be noted that the hydraulic lifting cylinders 42a and 42b would likely be connected to the hydraulic system of the field sprayer vehicle 80 which is already a part of the field sprayer vehicle 80, and such connections would be understood by those skilled in the art of hydraulic devices. This also permits the tool bar mounting structure 10, particularly hydraulic lifting cylinders 42a and 42b, to be controlled from within the cab structure 90 of the field sprayer vehicle 80, as was mentioned previously, and thus the tool bar mounting structure 10 functions as if it were an integral part of the field sprayer vehicle 80, which renders the present invention superior to the majority of prior art devices.

It is to be understood that numerous additions, modifications, and substitutions may be made to the tool bar mounting structure 10 of the present invention which fall within the intended broad scope of the appended claims. For example, the size, shape, and construction materials used in connection with the tool bar mounting structure 10 may be modified or changed so long as the functional characteristics of the present invention are neither degraded nor destroyed. Furthermore, although the mounting structure for mounting the tool bar mounting structure 10 on the field sprayer vehicle 80 has been described with some particularity, it is to be understood that many modifications may be made to the particular mounting structure which will permit the tool bar mounting structure 10 to be properly and safely mounted on field sprayer vehicle 80, and such modifications will likely be necessary depending on the model of field sprayer vehicle 80 with which the present invention is to be used. Also, while the down pressure shock absorber structure 60 has been described with some particularity, variations in the structure may be contemplated so long as the intended function of providing down pressure to the main mount beams 20a and 20b is maintained. Finally, although the main mount beam lifting mechanism 40 has also been described with some particularity, modifications to that mechanism are certainly contemplated, as various mechanisms are known for vertically adjusting a mounting beam relative to a ground surface, and inclusion of such variations should be understood to be a part of this disclosure.

There has therefore been shown and described a tool bar mounting structure 10 for a self-propelled field sprayer vehicle which accomplishes at least all of its intended objectives.

I claim:

1. A tool bar mounting structure for a field sprayer vehicle having a chassis, front and rear wheels and power means, said tool bar mounting structure comprising:
a chassis mount beam adapted to be mounted on the chassis of a field sprayer vehicle;
at least one main mount beam having a pivot mount end and a tool bar connection end, said pivot mount end of said at least one main mount beam pivotably mounted on said chassis mount beam, said at least one main mount beam extending from said chassis mount beam underneath the field sprayer vehicle;
a main mount beam lifting mechanism connected at the lower end to said at least one main mount beam and adapted for connection at the upper end thereof to the chassis of the field sprayer vehicle for raising and lowering of said tool bar connection end of said at least one main mount beam relative to the field sprayer vehicle;
shock absorber means mounted on said at least one main mount beam and connectable to the field sprayer vehicle for generally controlling and limiting vertical movement of said tool bar connection end of said at least one main mount beam; and
upon said tool bar mounting structure being mounted on a field sprayer vehicle, said tool bar connection end being positioned between the front and rear wheels whereby a tool bar mounted thereon is positioned between the front and rear wheels of the field sprayer vehicle.

2. The tool bar mounting structure of claim 1 further comprising a chassis mount beam mounting plate mounted on the upper end of said chassis mount beam, said chassis mount beam mounting plate contacting the chassis of the field sprayer vehicle adjacent the forward end thereof and being releasably connected thereto.

3. The tool bar mounting structure of claim 1 wherein said at least one main mount beam comprise a pair of main mount beams connected to a pair of main mount beam mounting brackets mounted on a main mount beam mounting arm mounted on said lower end of said chassis mount beam, said pair of main mount beams pivotably mounted on said pair of main mount beam mounting brackets by bolts which extend through the main mount beam mounting brackets and through said pivot mount ends of each of said pair of main mount beams such that said pair of main mount beams are pivotable about said bolts in generally parallel upright planes.

4. The tool bar mounting structure of claim 1 wherein said main mount beam lifting mechanism comprises a pair of hydraulic lifting cylinders which are each pivotably connected to one of a pair of cylinder mounting brackets mountable to the chassis of the field sprayer vehicle, said lower ends of said pair of hydraulic lifting cylinders being pivotably connected to a lifting mechanism support beam which extends between and connects said lower ends of said pair of hydraulic lifting cylinders underneath said at least one main mount beam.

5. The tool bar mounting structure of claim 4 wherein said main mount beam lifting mechanism further comprises a pair of support beam mounting struts extending rearwards towards said tool bar connection end of said at least one main mount beam and connected to said lifting mechanism support beam, said pair of support beam mounting struts pivotably mounted to the underside of said at least one main mount beam whereby upon said at least one main mount beam being pivoted upwards via external forces, said at least one main mount beam would lift off of said lifting mechanism support beam without substantially compressing said at least one hydraulic cylinder, then fall back down onto said lifting mechanism support beam thereby generally preventing damage to said at least one hydraulic lifting cylinders.

6. The tool bar mounting structure of claim 1 wherein said shock absorber means comprises a down pressure shock absorber structure including at least one upright support leg mounted on and extending upwards from said at least one of said main mount beams, a top spring mount beam mounted on top of said at least one upright support leg having a plurality of spring mount holes formed extending generally vertically through said top spring mount beam, spring mount means operatively connected to said at least one main mount beams and at least one down pressure spring extending between one of said plurality of spring mount holes and said spring mount means, said at least one down pressure spring operative to bias said top spring mount beam towards said at least one main mount beam thereby generally controlling and limiting vertical movement of said tool bar connection end of said at least one main mount beam.

7. A tool bar mounting structure for a field sprayer vehicle having a chassis, front and rear wheels and power means, said tool bar mounting structure comprising:
a downwardly depending chassis mount beam having an upper end and a lower end, said chassis mount beam adapted to be mounted on the chassis of a field sprayer vehicle;
at least one main mount beam having a pivot mount end and a tool bar connection end, said pivot mount end of said at least one main mount beam pivotably mounted on said lower end of said chassis mount beam, said at least one main mount beam extending from said chassis mount beam underneath the field sprayer vehicle;
a main mount beam lifting mechanism including at least one hydraulic lifting cylinder connected at the lower end to said at least one main mount beam and adapted for connection of the upper end of said at least one hydraulic lifting cylinder to the chassis of the field sprayer vehicle for raising and lowering of said tool bar connection end of said at least one main mount beam relative to the field sprayer vehicle;
shock absorber means mounted on said at least one main mount beam and connectable to the field sprayer vehicle for generally controlling and limiting vertical movement of said tool bar connection end of said at least one main mount beam; and
upon said tool bar mounting structure being mounted on a field sprayer vehicle, said tool bar connection end being positioned between the front and rear wheels whereby a tool bar mounted thereon is positioned between the front and rear wheels of the field sprayer vehicle.

8. The tool bar mounting structure of claim 7 further comprising a chassis mount beam mounting plate mounted on the upper end of said chassis mount beam, said chassis mount beam mounting plate contacting the chassis of the field sprayer vehicle adjacent the forward end thereof and being releasably connected thereto.

9. The tool bar mounting structure of claim 7 wherein said at least one main mount beam comprise a pair of main mount beams connected to a pair of main mount beam mounting brackets mounted on a main mount beam mounting arm mounted on said lower end of said chassis mount beam, said pair of main mount beams pivotably mounted on said pair of main mount beam mounting brackets by bolts which extend through the main mount beam mounting brackets and through said pivot mount ends of each of said pair of main mount beams such that said pair of main mount beams are pivotable about said bolts in generally parallel upright planes.

10. The tool bar mounting structure of claim 7 wherein said main mount beam lifting mechanism comprises a pair of hydraulic lifting cylinders which are each pivotably connected to one of a pair of cylinder mounting brackets mountable to the chassis of the field sprayer vehicle, said lower ends of said pair of hydraulic lifting cylinders being pivotably connected to a lifting mechanism support beam which extends between and connects said lower ends of said pair of hydraulic lifting cylinders underneath said at least one main mount beam.

11. The tool bar mounting structure of claim 10 wherein said main mount beam lifting mechanism further comprises a pair of support beam mounting struts extending rearwards towards said tool bar connection end of said at least one main mount beam and connected to said lifting mechanism support beam, said pair of support beam mounting struts pivotably mounted to the underside of said at least one main mount beam whereby upon said at least one main mount beam being pivoted upwards via external forces, said at least one main mount beam would lift off of said lifting mechanism support beam without substantially compressing said at least one hydraulic cylinder, then fall back down onto said lifting mechanism support beam thereby generally preventing damage to said at least one hydraulic lifting cylinders.

12. The tool bar mounting structure of claim 7 wherein said shock absorber means comprises a down pressure shock absorber structure including at least one upright support leg mounted on and extending upwards from said at least one of said main mount beams, a top spring mount beam mounted on top of said at least one upright support leg having a plurality of spring mount holes formed extending generally vertically through said top spring mount beam, spring mount means operatively connected to said at least one main mount beams and at least one down pressure spring extending between one of said plurality of spring mount holes and said spring mount means, said at least one down pressure spring operative to bias said top spring mount beam towards said at least one main mount beam thereby generally controlling and limiting vertical movement of said tool bar connection end of said at least one main mount beam.

13. In combination:
a self-propelled field sprayer vehicle having a chassis, front and rear wheels, an hydraulic power system and power means for propelling said field sprayer vehicle; and
a tool bar mounting structure including;
a chassis mount beam having an upper end and a lower end, said chassis mount beam adapted to be mounted on said chassis of said field sprayer vehicle;
at least one main mount beam having a pivot mount end and a tool bar connection end, said pivot mount end of said at least one main mount beam pivotably mounted on said lower end of said chassis mount beam, said at least one main mount beam extending from said chassis mount beam underneath said field sprayer vehicle;
a main mount beam lifting mechanism including at least one hydraulic lifting cylinder in operative connection with said hydraulic power system of said field sprayer vehicle and connected at the lower end to said at least one main mount beam and connected at the upper end thereof to said chassis of said field sprayer vehicle for raising and lowering of said tool bar connection end of said at least one main mount beam relative to said field sprayer vehicle;
shock absorber means mounted on said at least one main mount beam and connectable to said field sprayer vehicle for generally controlling and limiting vertical movement of said tool bar connection end of said at least one main mount beam relative to the ground surface over which said field sprayer vehicle is traveling; and
upon said tool bar mounting structure being mounted on said field sprayer vehicle, said tool bar connection end is positioned between said front and rear wheels whereby a tool bar mounted thereon is positioned between said front and rear wheels of said field sprayer vehicle.

14. The combination of claim 13 further comprising a chassis mount beam mounting plate mounted on the upper end of said chassis mount beam, said chassis mount beam mounting plate contacting said chassis of said field sprayer vehicle adjacent the forward end thereof and being releasably connected thereto.

15. The combination of claim 13 wherein said at least one main mount beam comprise a pair of main mount beams connected to a pair of main mount beam mounting brackets mounted on a main mount beam mounting arm mounted on said lower end of said chassis mount beam, said pair of main mount beams pivotably mounted on said pair of main mount beam mounting brackets by bolts which extend through the main mount beam mounting brackets and through said pivot mount ends of each of said pair of main mount beams such that said pair of main mount beams are pivotable about said bolts in generally parallel upright planes.

16. The combination of claim 13 wherein said main mount beam lifting mechanism comprises a pair of hydraulic lifting cylinders which are each pivotably connected to one of a pair of cylinder mounting brackets mountable to the chassis of the field sprayer vehicle, said lower ends of said pair of hydraulic lifting cylinders being pivotably connected to a lifting mechanism support beam which extends between and connects said lower ends of said pair of hydraulic lifting cylinders underneath said at least one main mount beam.

17. The combination of claim 16 wherein said main mount beam lifting mechanism further comprises a pair of support beam mounting struts extending rearwards towards said tool bar connection end of said at least one main mount beam and connected to said lifting mechanism support beam, said pair of support beam mounting struts pivotably mounted to the underside of said at least one main mount beam whereby upon said at least one main mount beam being pivoted upwards via external forces, said at least one main mount beam would lift off of said lifting mechanism support beam without substantially compressing said at least one hydraulic cylinder, then fall back down onto said lifting mechanism support beam thereby generally preventing damage to said at least one hydraulic lifting cylinders.

18. The combination of claim 13 wherein said shock absorber means comprises a down pressure shock absorber structure including at least one upright support leg mounted on and extending upwards from said at least one of said main mount beams, a top spring mount beam mounted on top of said at least one upright support leg having a plurality of spring mount holes formed extending generally vertically through said top spring mount beam, spring mount means operatively connected to said at least one main mount beams and at least one down pressure spring extending between one of said plurality of spring mount holes and said spring mount means, said at least one down pressure spring operative to bias said top spring mount beam towards said at least one main mount beam thereby generally controlling and limiting vertical movement of said tool bar connection end of said at least one main mount beam.
